(19) United States
(12) Patent Application Publication
(10) Pub. No.: US 2012/0092516 A1
(43) Pub. Date: Apr. 19, 2012

(54) IMAGING DEVICE AND SMILE RECORDING PROGRAM

(75) Inventor: Kazuaki Hata, Osaka (JP)

(73) Assignee: SANYO ELECTRIC CO., LTD., Moriguchi-shi, Osaka (JP)

(21) Appl. No.: 13/142,160

(22) PCT Filed: Dec. 22, 2009
(86) PCT No.: PCT/JP2009/007112

§ 371 Date: Aug. 1, 2011

(30) Foreign Application Priority Data
Dec. 24, 2008 (JP) 2008-326785

(51) Int. Cl. H04N 5/228

(52) U.S. Cl. 348/222.1; 348/E05.031

(57) ABSTRACT

A digital camera (10) includes a CPU (24). The CPU (24) repetitively captures an object scene image on an imaging surface (14f) by controlling an image sensor (14), detects a facial image from each object scene image thus created, judges whether or not the face of each of the detected facial image has a smile, and records the object scene image created after the judgment result about which at least one detected facial image is changed from a state indicating a non-smile to a state indicating a smile into the recording medium (38) by controlling the I/F (36). Also, in a certain mode, an area is assigned to each object scene image in response to an area designating operation via the key input device (26), and execution of the recording processing is restricted on the basis of at least a positional relationship between the facial image which is judged as having a smile and the assigned area. In another mode, such a restriction is not imposed.

### TECHNICAL FIELD

The present invention relates to an imaging device and smile recording program. More specifically, the present invention relates to an imaging device and smile recording program which repetitively images an object scene, and record the object scene image created after a smile is detected.

### DESCRIPTION OF THE RELATED ARTS

One example of an imaging device of such a kind is disclosed in a patent document 1. In the related art, a facial image is extracted from each of the object scene images to thereby analyze a time-series change of the facial images, and by predicting a timing when the facial image matches a predetermined pattern, a main image imaging is performed, to thereby shorten a time lag from the face detection to the main image imaging.

### [Patent Document 1] Japanese Patent Application Laying-Open No. 2007-215064 [H04N 5/232, G03B 15/00, G03B 17/38, H04N 101/00]

### SUMMARY OF THE INVENTION

### Problems to be Solved by the Invention

In the imaging device of such a kind, in a situation in which there are a plurality of faces within an object scene, recording processing is performed in response to a smile different form a smile targeted by a user, so that the target smile could not sometimes be recorded. However, the related art does not solve the problem.

Therefore, it is a primary object of the present invention to provide a novel imaging device and novel smile recording program.

Another object of the present invention is to provide an imaging device and smile recording program capable of recording a target smile at a high probability.

### Means for Solving the Problems

The present invention employs following features in order to solve the above-described problems. It should be noted that reference numerals inside the parentheses and the supplementary explanations show one example of a corresponding relationship with the embodiments described later for easy understanding of the present invention, and do not limit the present invention.

A first invention is an imaging device, comprising: an imager which repetitively captures an object scene image formed within an imaging area on an imaging surface; an assigner which assigns a smile area to the imaging area in response to an area designating operation via an operator; and a smile recorder which performs smile recording processing for detecting a smiling image from each of the object scene images created by the imager and recording the object scene image including the smiling image, within the smile area if the smile area is assigned by the assigner, and performs the processing within the imaging area if the smile area is not assigned by the assigner.

In an imaging device (10) according to the first invention, an object scene image formed within an imaging area (Ep) on an imaging surface (14f) is repetitively captured by an imager (14, S231, S249). When an area designating operation is performed via an operator (26), an assigner (S235) assigns a smile area (Es0 to Es4) to the imaging area. A smile recorder (S241 to S247, S251) performs smile recording processing for detecting a smiling image from each of the object scene images created by the imager and recording the object scene image including the smiling image, within the smile area if the smile area is assigned by the assigner, and performs the processing within the imaging area if the smile area is not assigned by the assigner.

According to the first invention, by restricting a smile recording execution range to the smile area according to an area designating operation, it is possible to prevent an execution of the recording processing in response to a smile other than a target smile before the target smile is detected from occurring. Consequently, it is possible to heighten a possibility of recording the target smile. If the area designating operation is not performed, or if a cancel operation is performed after the area designating operation, arbitrary smiles can be recorded in a wide range.

A second invention is an imaging device comprising: an imager which repetitively captures an object scene image formed on an imaging surface; a detector which detects a facial image from each of the object scene images created by the imager; a judger which judges whether or not a face of each facial image detected by the detector has a smile; a recorder which records in a recording medium an object scene image created by the imager after the judgment result by the judger about at least one facial image detected by the detector changes from a state indicating a non-smile to a state indicating a smile; an assigner which assigns an area to each of the object scene images in response to an area designating operation via an operator in a specific mode; and a restricter which restricts the execution of the recording processing by the recorder on the basis of at least a positional relationship between the facial image that is judged as having a smile by the judger and the area assigned by the assigner.

In an imaging device (10) according to the second invention, an object scene image formed on an imaging surface (14f) is repetitively captured by an imager (14, S25, S39, S105, S113). A detector (S161 to S177) detects a facial image from each of the object scene images created by the imager, and a judger (S71 to S97, S121 to S135) judges whether or not a face of each facial image detected by the detector has a smile. A recorder (36, S31, S41, S111, S115) records in a recording medium (38) an object scene image created by the imager after the judgment result by the judger about at least one facial image detected by the detector changes from a state indicating a non-smile to a state indicating a smile.

When an area designating operation is performed via an operator (26) in the specific mode, an assigner (S63) assigns an area to each of the object scene images, and a restricter (S33 to S37) restricts the execution of the recording processing by the recorder on the basis of at least a positional relationship between the facial image that is judged as having a smile by the judger and the area assigned by the assigner.

According to the second invention, in the specific mode, on the basis of a positional relationship between the area designated by the user and the smile detected by the detector and the judger, the restricter restricts the recording operation by the recorder, and whereby, it is possible to prevent an execution of the recording processing in response to a smile other than a target smile before the target smile is detected from occurring. Consequently, the possibility of being capable of recording the target smile is heightened. In another mode, there is no restriction, capable of recording arbitrary smiles in a wide range.

Here, in one embodiment, the imager performs a through imaging at first, and pauses the through imaging to perform a main imaging in response to a change from the non-smile state to the smile-state, and the recorder records the object scene image by the main imaging. In another embodiment, the imager performs a motion image imaging to store a plurality of object scene images thus obtained in the memory (30c), and reads any one of the object scene images from the memory (30c) in response to a change from the non-smile state to the smile state, and the recorder records the read object scene image. In either embodiment, the restricter restricts the execution of the recording processing by the recorder, capable of recording the target smile at a high probability.

A third invention is an imaging device according to the second invention, wherein the restricter allows the execution of the recording processing by the recorder in a case that the facial image that is judged as having a smile by the judger is positioned within the area assigned by the assigner and restricts execution of the recording processing by the recorder in a case that the facial image that is judged as having a smile by the judger is positioned out of the area assigned by the assigner (S33).

In the third invention, the recording processing is not executed when a smile is detected out of the area, and is executed only when a smile is detected within the area.

Here, the restricter restricts the execution of the recording processing by the recorder by stopping the recorder itself in one embodiment, but the restriction may be performed by stopping the judger in another embodiment, and thus, the processing amount is reduced. Alternatively, the restriction can also be performed by invalidating the judgment result by the judger.

A fourth invention is an imaging device according to the third invention, further comprising a focus adjuster (12, 16, S155) which makes a focus adjustment so as to come into focus with one of the facial images detected by the detector, and the restricter, in a case that there are an into-focus facial image and an out-of-focus facial image within the area assigned by the assigner, notes the into-focus facial image (S35, S37).

In the fourth invention, in a case that there are an into-focus facial image and an out-of-focus facial image are mixed within the area, the restricter notes the into-focus facial image, that is, the restriction is performed based on not the judgment result about the out-of focus facial image but the judgment result about the into-focus facial image.

According to the fourth invention, by noting the into-focus facial image, the face judgment can properly be performed, capable of heightening the possibility of recording a target smile.

A fifth invention is an imaging device according to the fourth invention, further comprising a controller (S221, S223) which controls a position of a focus evaluating area (Efcs) to be referred by the adjuster so as to come into focus with a facial image positioned within the area assigned by the assigner out of the facial images detected by the detector.

In one embodiment, the restricter forcibly moves the focus evaluating area into the designated smile area when the focus evaluating area (Efcs) to be referred by the focus adjuster is positioned out of the area (designated smile area) assigned by the assigner.

According to the fifth invention, a possibility of coming into focus with the target face is heightened, and eventually, the possibility of recording the target smile is more heightened.

A sixth invention is an imaging device according to any one of the first to sixth inventions, wherein the area designating operation is an operation for designating one from a plurality of fixed areas (Es0 to Es4).

A seventh invention is an imaging device according to the sixth invention, wherein parts of the plurality of fixed areas are overlapped with each other.

According to the seventh invention, an area designating operation when the target face is positioned around the boundary of the area is made easy.

Here, the area designating operation may be an operation for designating at least any one of a position, a size and a shape of a variable area.

An eighth invention is an imaging device according to any one of the first to seventh inventions, further comprising: a through displayer (32) which displays a through-image based on each object scene image created by the imager on a display (34); and a depicter (42, S57) which depicts a box image representing the area designated by the area designating operation on the through-image of the display.

According to the eighth invention, by displaying the box image representing the area on the through-image (makes an on-screen display), it becomes easy to perform an operation of adjusting the angle of view and of designating an area.

Here, in one embodiment, the depicter starts to depict the box image in response to a start of the area designating operation, and stops depicting the box image in response to a completion of the area designating operation. In another embodiment, the depicter always depicts the box image, and may change the manner of the box image (color, brightness, thickness of line, etc.) in response to the start and/or the completion of the area designating operation.

A ninth invention is an smile recording program causing a processor (24) of an imaging device (10) including an image sensor (14) having an imaging surface (14f), a recorder (36) recording an image based on an output from the image sensor on a recording medium (38) and an operator (26) to be operated by a user to execute: an imaging step (S231, S249) for repetitively capturing an object scene image formed within an imaging area (Ep) on an imaging surface by controlling the image sensor; an assigning step (S235) for assigning a smile area (Es0 to Es4) to the imaging area in response to an area designating operation via the operator; and a smile recording step (S241 to S247, 251) for performing smile recording processing of detecting a smiling image from each of the object scene images created by the imaging step and recording the object scene image including the smiling image, within the smile area if the smile area is assigned by the assigner, and performing the processing within the imaging area if the smile area is not assigned by the assigner.

In the ninth invention as well, similar to the first invention, by the area designating operation, the possibility of being capable of recording the target smile is heightened. If the area designating operation is not performed, or if a cancel operation is performed after the area designating operation, arbitrary smiles can be recorded in a wide range.

A tenth invention is a smile recording program causing a processor (24) of an imaging device (10) including an image sensor (14) having an imaging surface (14f), a recorder (36) recording an image based on an output from the image sensor on a recording medium (38) and an operator (26) to be operated by a user to execute: an imaging step (S25, S39) for repetitively capturing an object scene image formed on the imaging surface by controlling the image sensor; an detecting step (S161 to S177) for detecting a facial image from each of the object scene images created by the imaging step; a judging step (S87 to S97, S125 to S135) for judging whether or not a face of each facial image detected by the detecting step has a smile; a smile recording step (S31 and S41) for recording in the recording medium (38) an object scene image created by the imaging step after the judgment result by the judging step about at least one facial image detected by the detecting step changes from a state indicating a non-smile to a state indicating a smile by controlling the recording step; an assigning step (S63) for assigning an area to each of the object scene images in response to an area designating operation via the operator in a specific mode; and a restricting step (S33 to S37) for restricting the execution of the recording processing by the smile recording step on the basis of at least a positional relationship between the facial image that is judged as having a smile by the judging step and the area assigned by the assigning step.

In the tenth invention as well, similar to the second invention, a possibility of being capable of recording the target smile is heightened in the specific mode, and arbitrary smiles can be recorded in a wide range in another mode.

An eleventh invention is a recording medium (40) storing a smile recording program corresponding to the ninth invention.

A twelfth invention is a recording medium (40) storing a smile recording program corresponding to the tenth invention.

A thirteenth invention is a smile recording method to be executed by the imaging device (10) corresponding to the first invention.

A fourteenth invention is a smile recording method to be executed by the imaging device (10) corresponding to the second invention.

The above described objects and other objects, features, aspects and advantages of the present invention will become more apparent from the following detailed description of the present invention when taken in conjunction with the accompanying drawings.

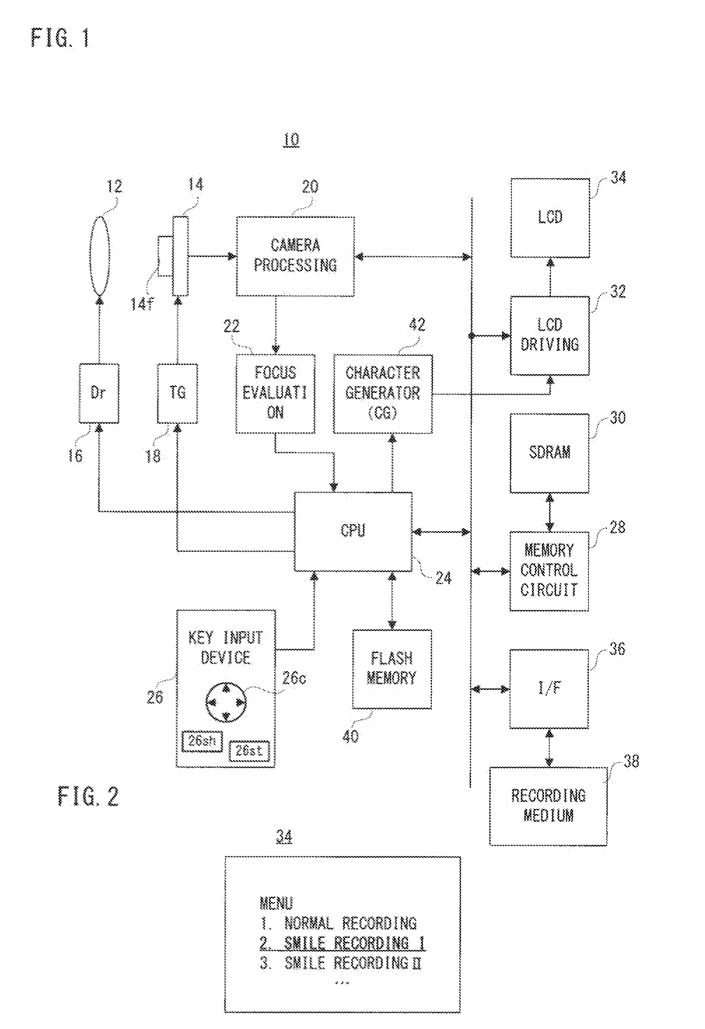

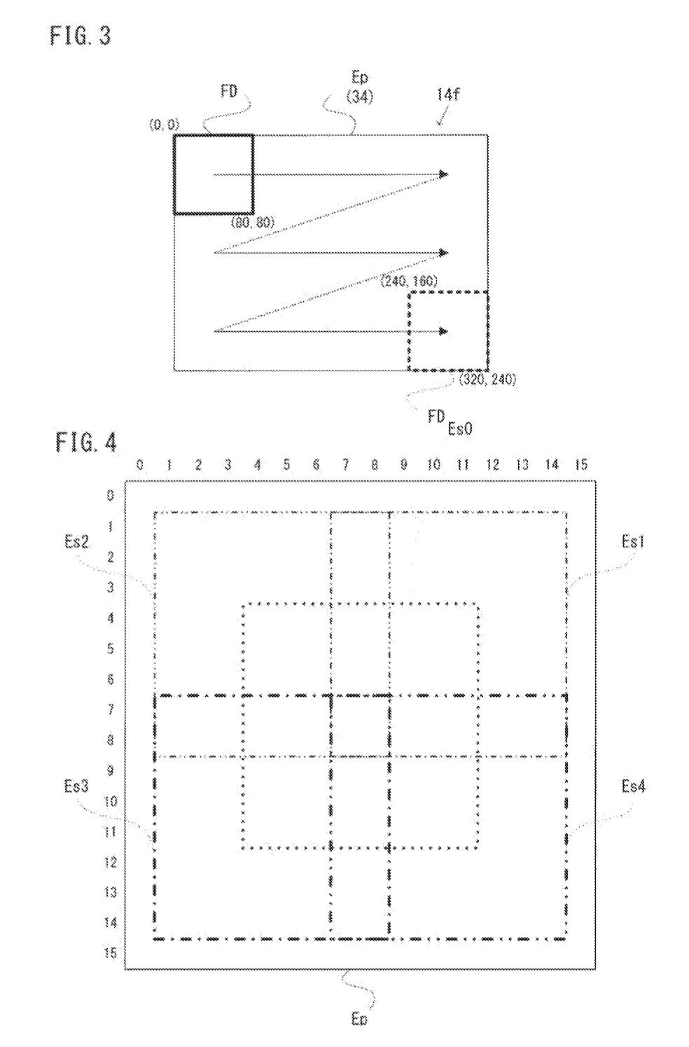

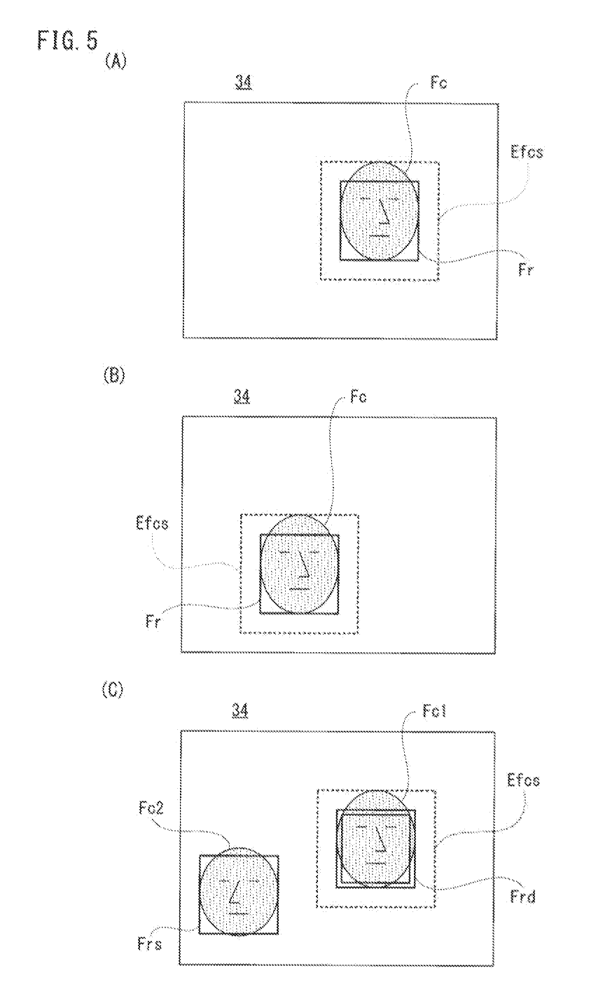

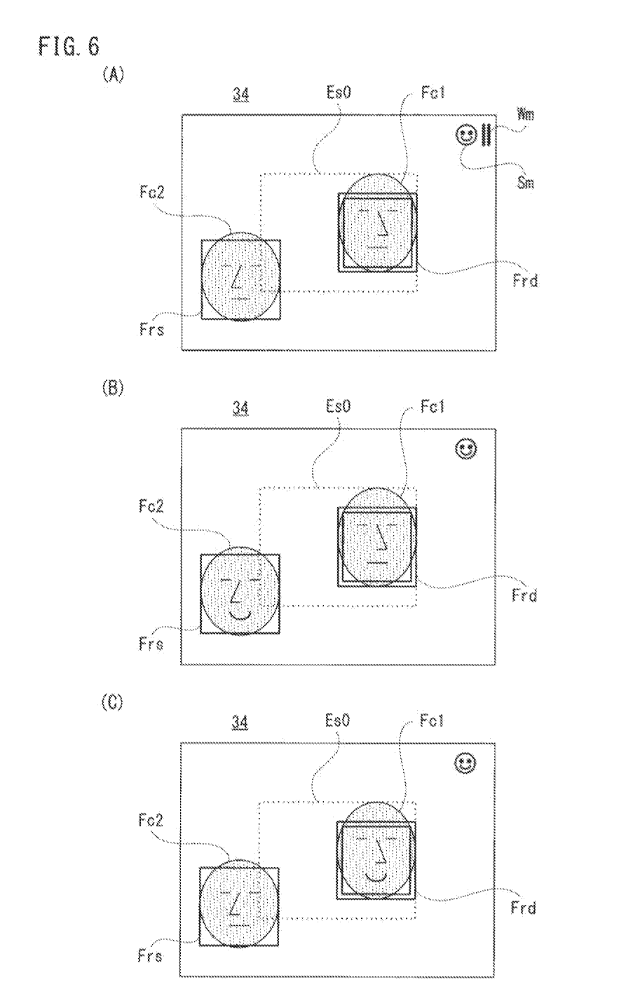

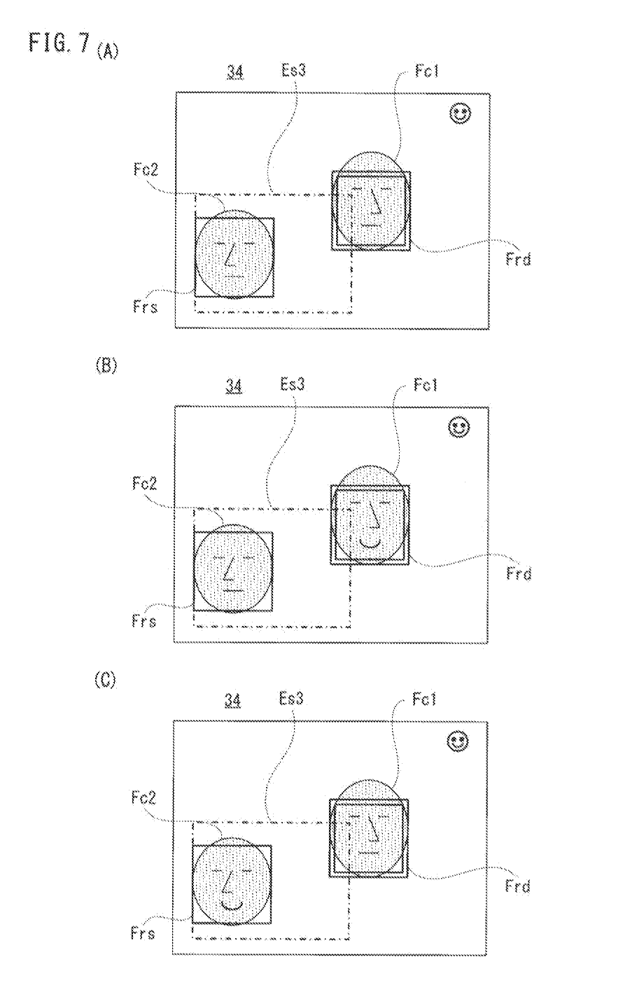

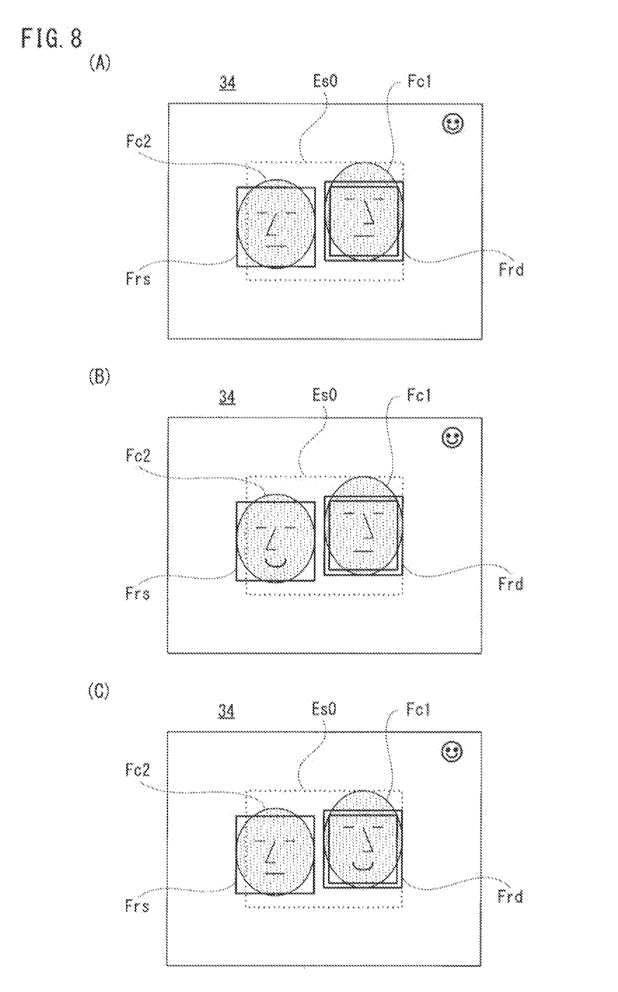

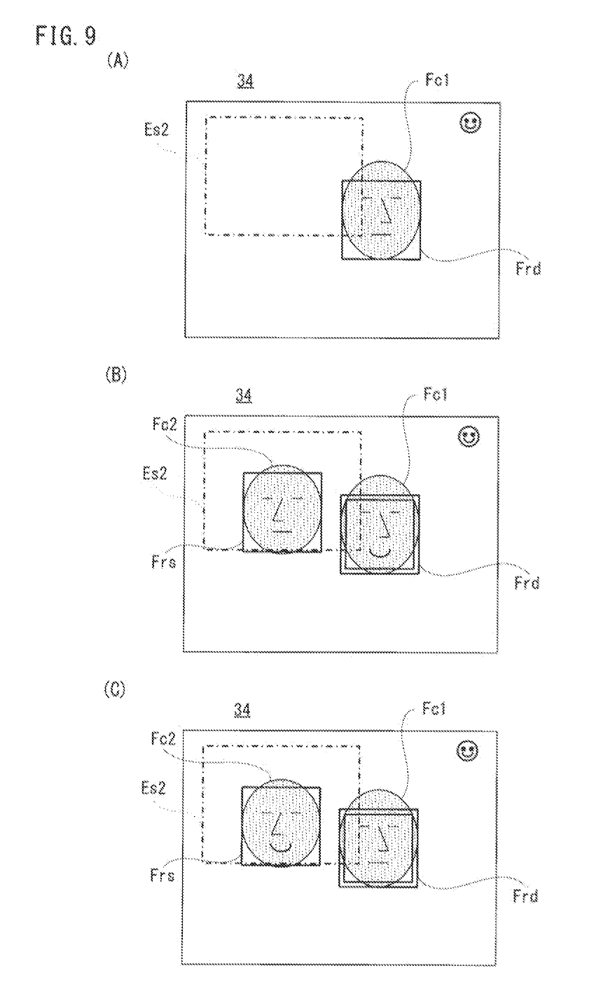

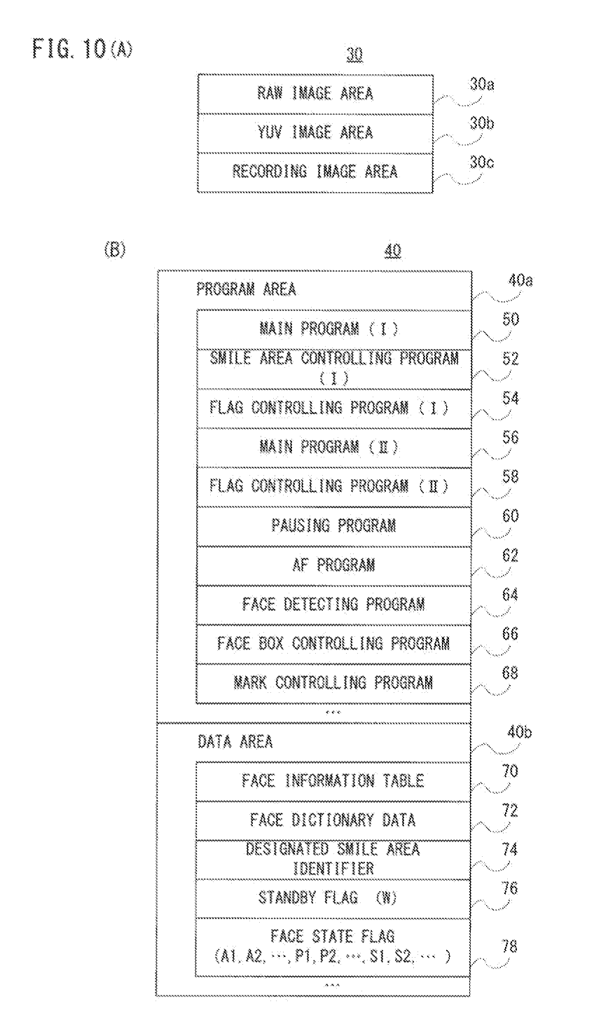

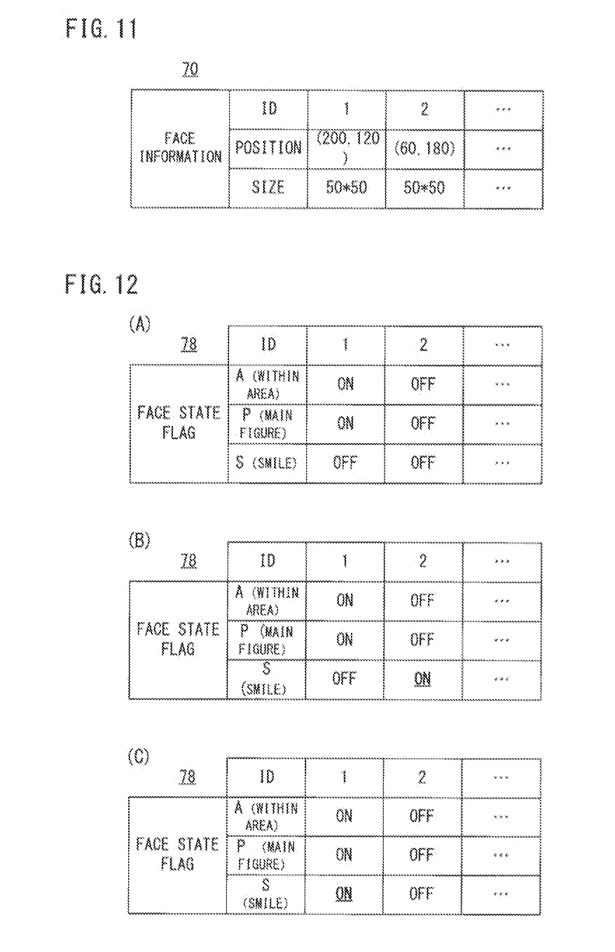

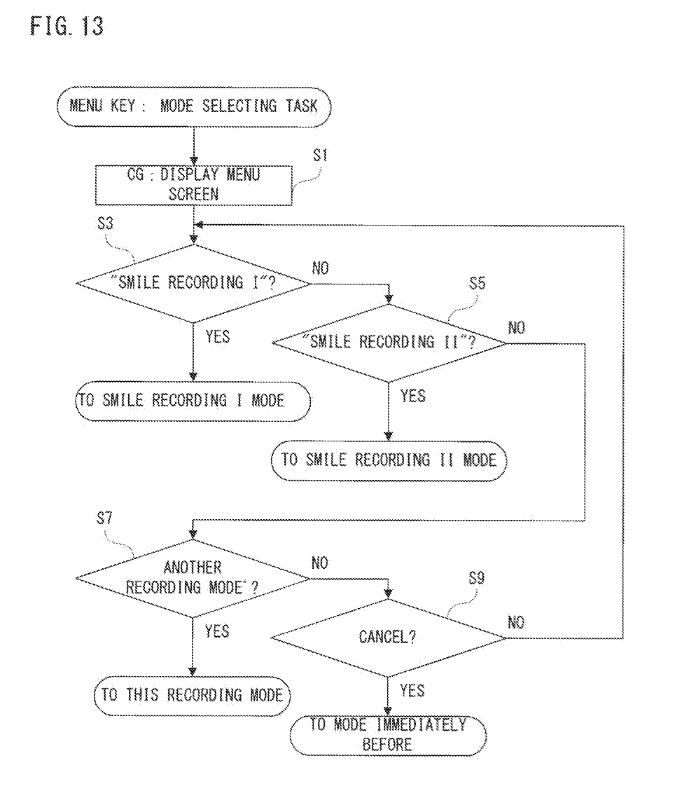

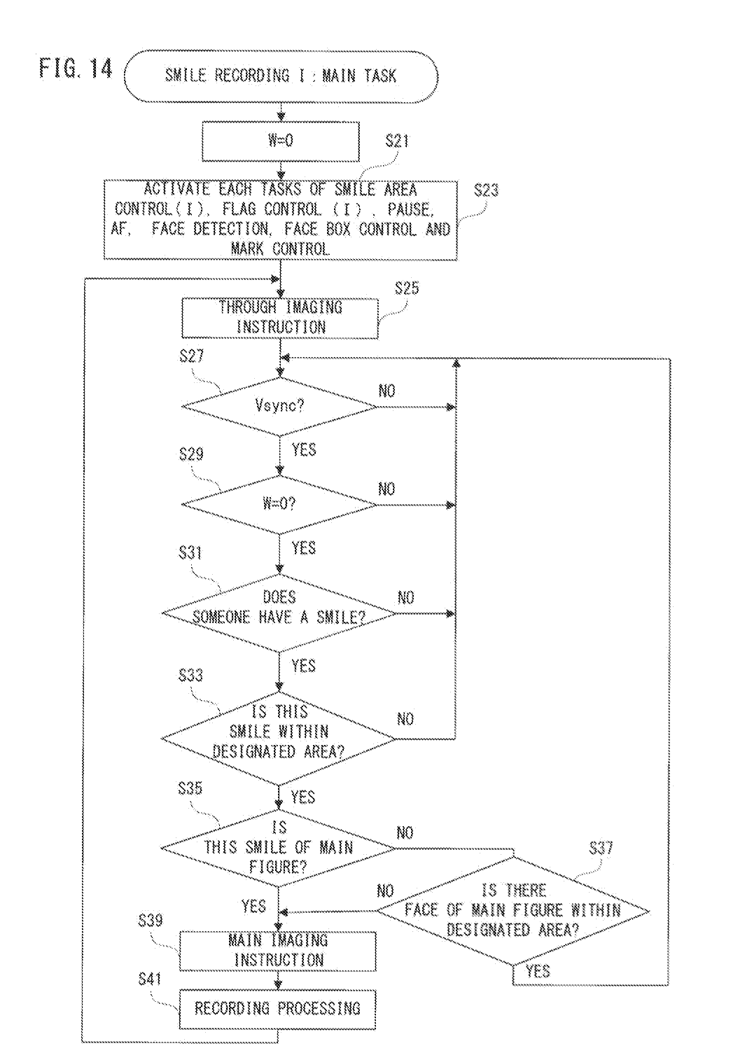

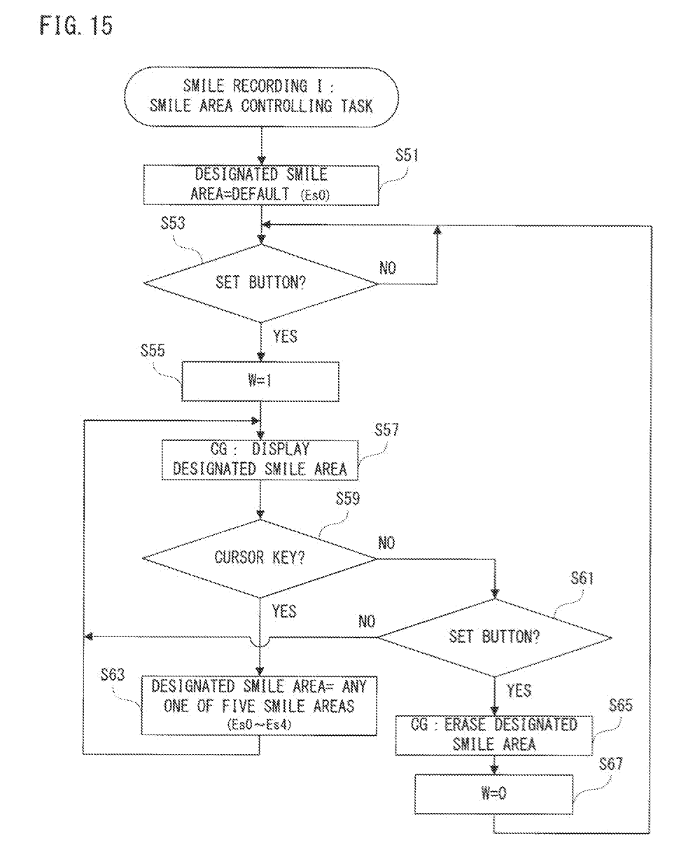

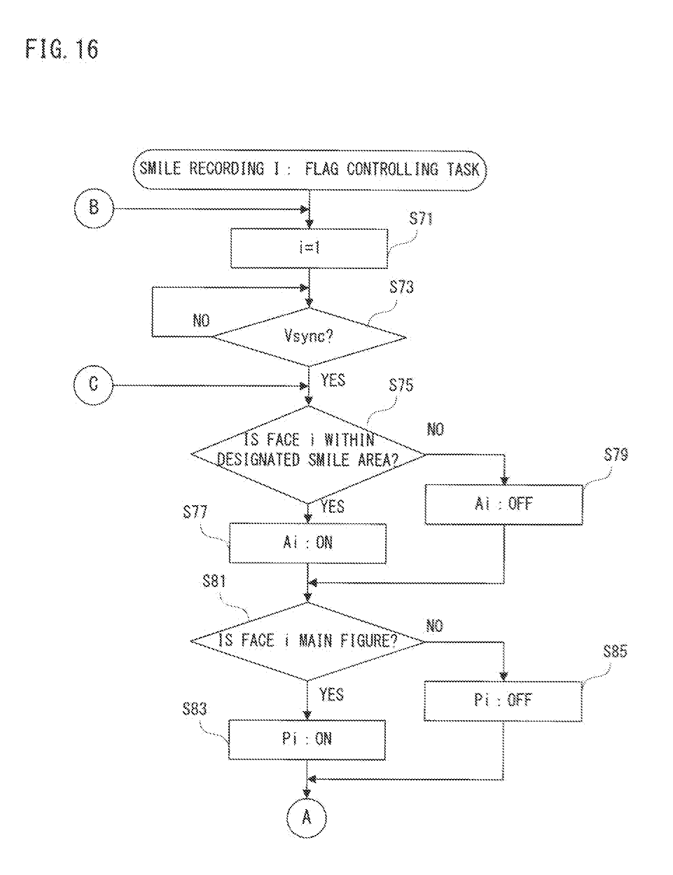

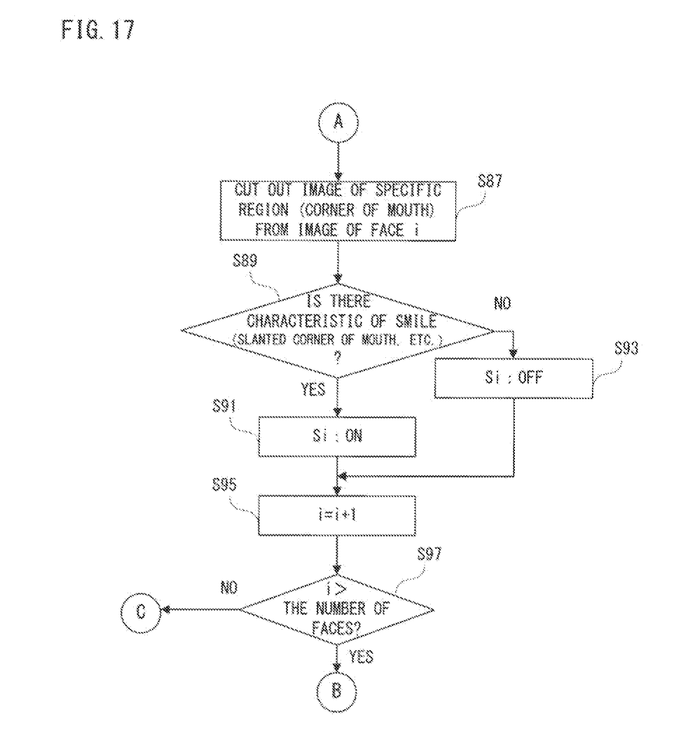

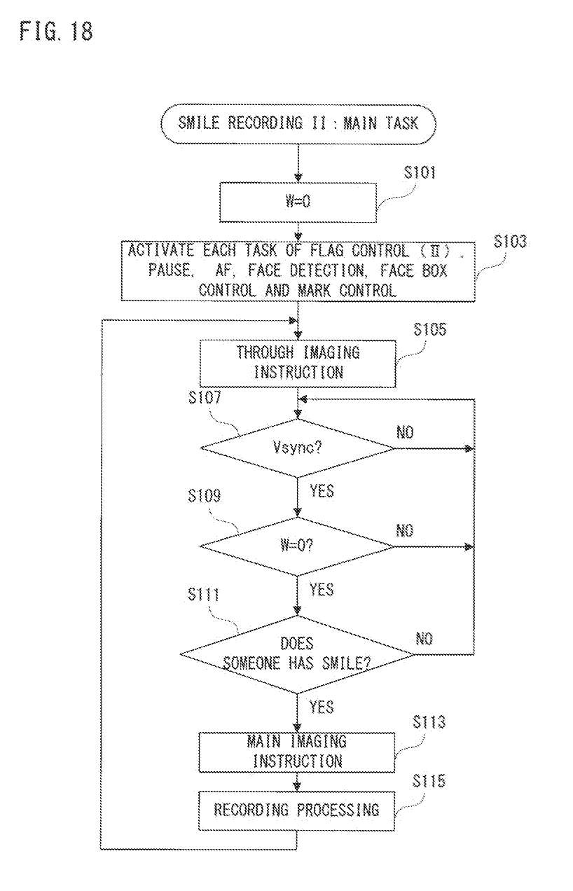

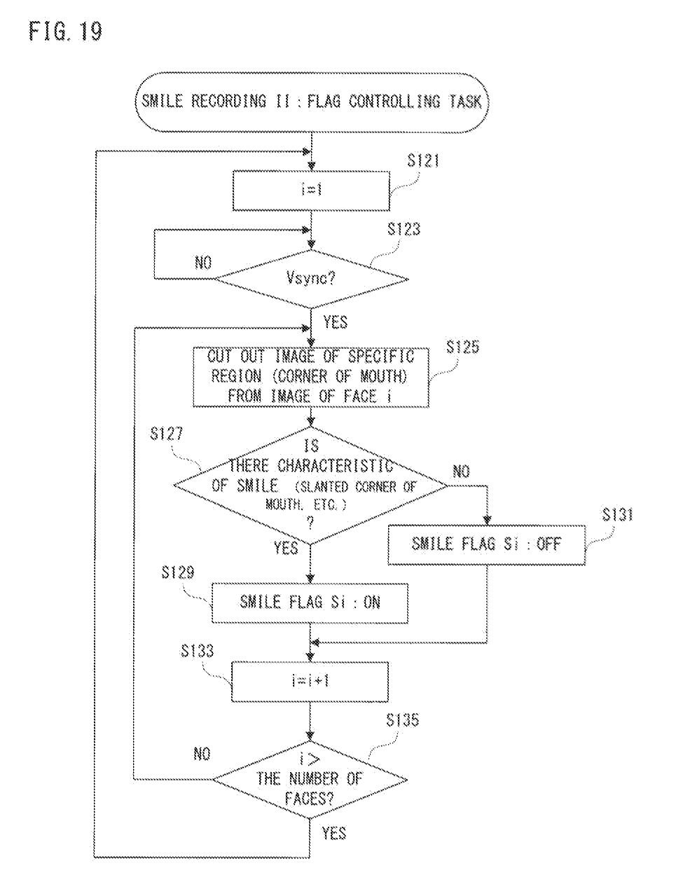

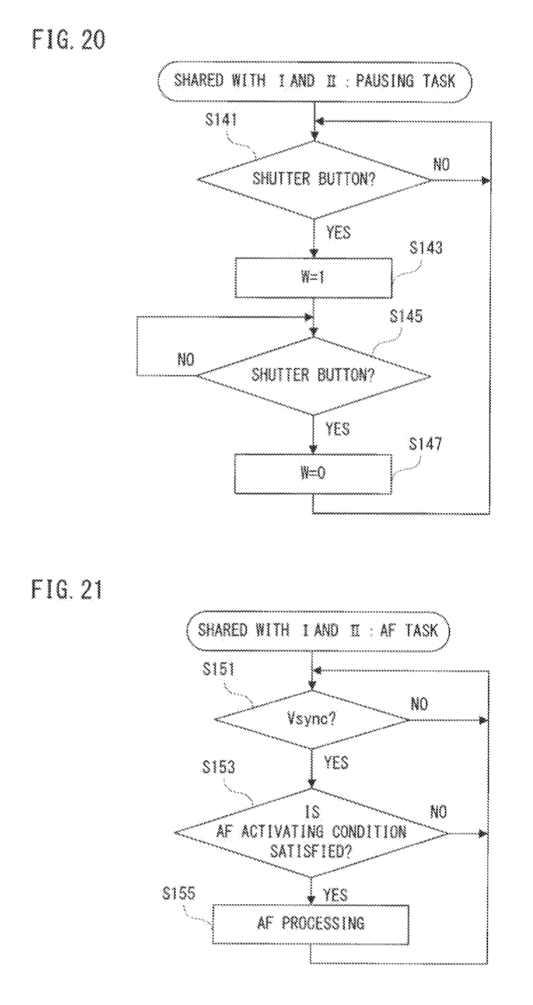

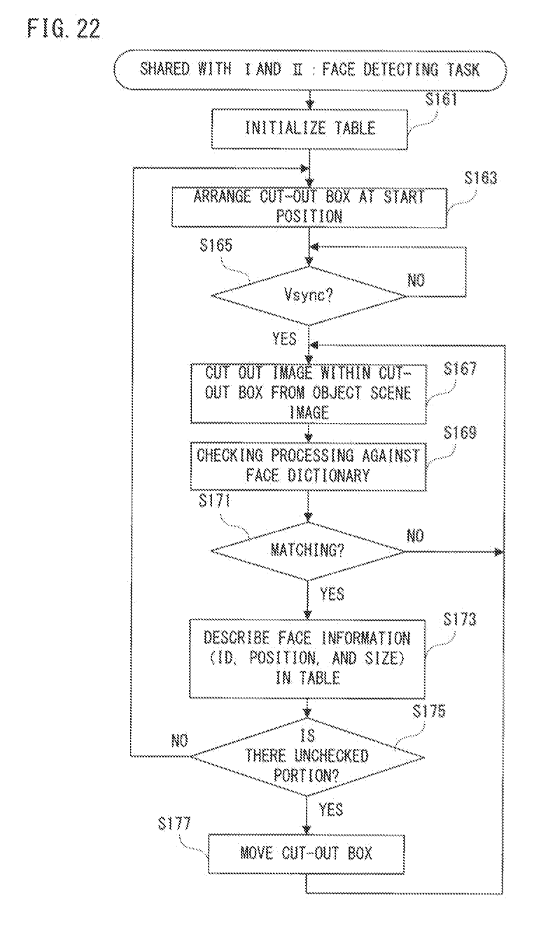

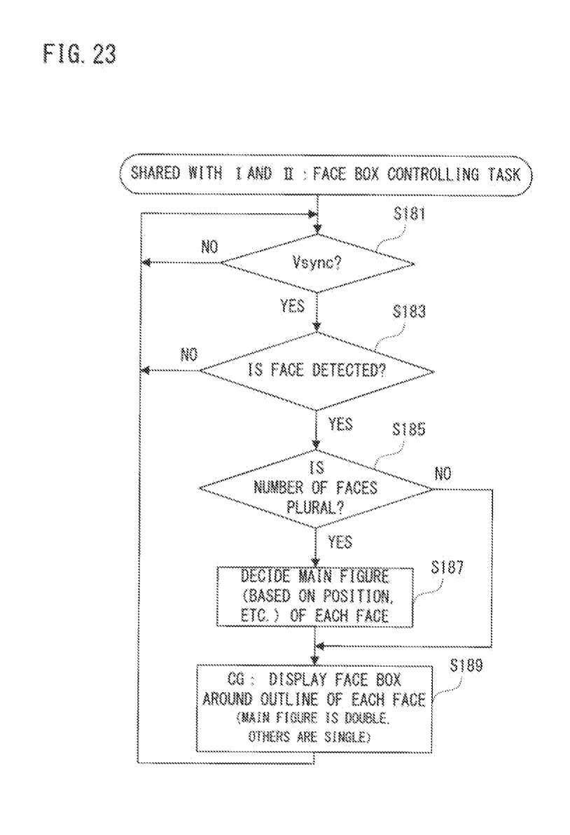

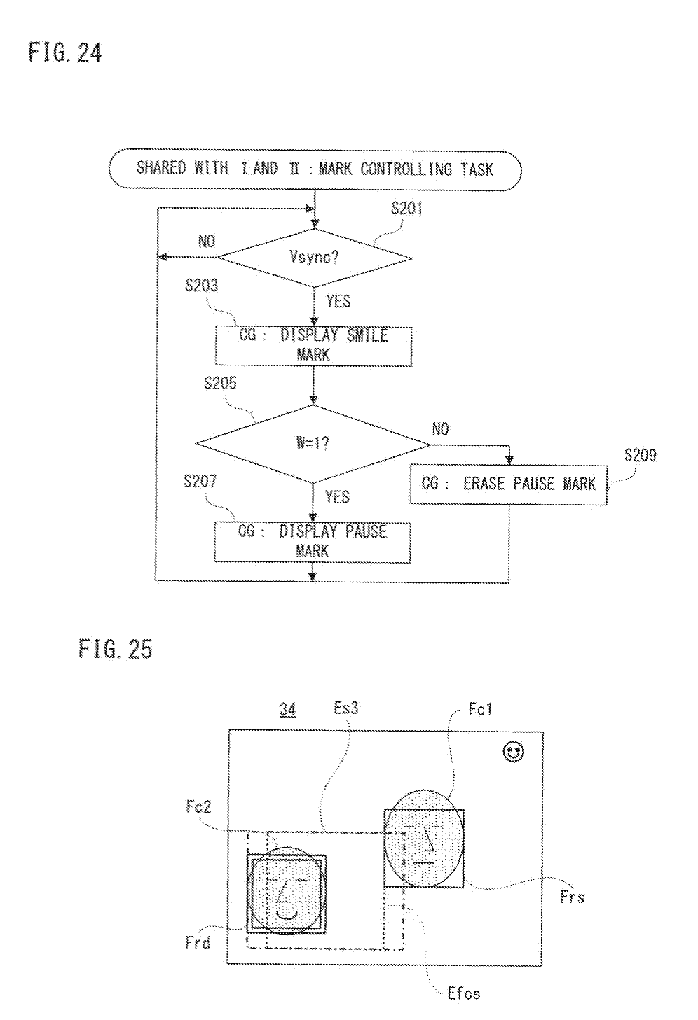

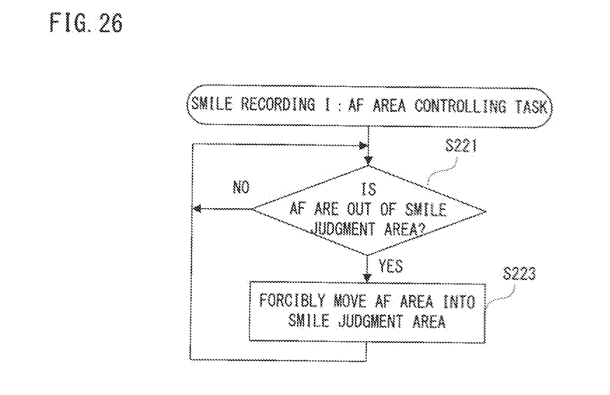

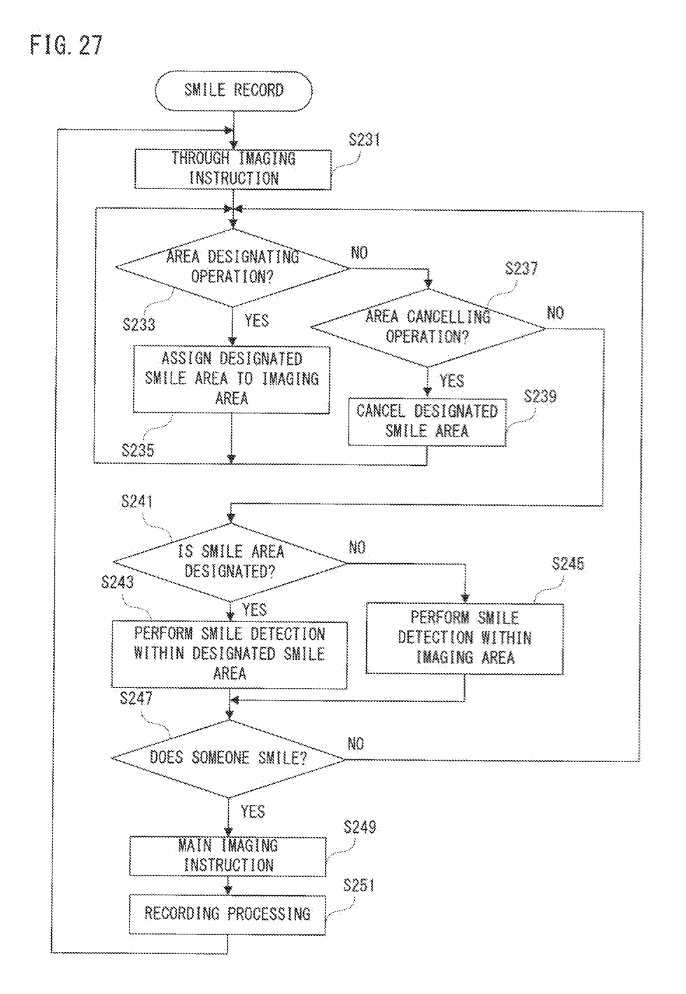

### BRIEF DESCRIPTION OF THE DRAWINGS

[Figure 1] FIG. 1 is a block diagram showing a configuration of one embodiment of the present invention.

[Figure 2] FIG. 2 is an illustrative view showing one example of a mode selecting screen applied to FIG. 1 embodiment.

[Figure 3] FIG. 3 is an illustrative view showing one example of face detecting processing applied to FIG. 1 embodiment.

[Figure 4] FIG. 4 is an illustrative view showing one example of a smile area applied to FIG. 1 embodiment.

[Figure 5] FIG. 5 is one example of a monitor screen applied to FIG. 1 embodiment and is an illustrative view showing changes of a face box and a focus evaluating area, and FIG. 5(A) shows an initial state, FIG. 5(B) shows a situation in which the face box and the focus evaluating area follow a movement of a face and FIG. 5(C) shows a situation in which the face box of a main figure is represented by a double line in a case that there are a plurality of faces.

[Figure 6] FIG. 6 is another example of the monitor screen applied to FIG. 1 embodiment and is an illustrative view in a case that there is only a main figure in a smile area, and FIG. 6(A) shows an initial state, FIG. 6(B) shows a situation in which a smile is detected out of the smile area, and FIG. 6(C) shows a situation in which a smile is detected within the smile area.

[Figure 7] FIG. 7 is a still another example of the monitor screen applied to FIG. 1 embodiment and is an illustrative view when there is only a subsidiary figure within the smile area, and FIG. 7(A) shows an initial state, FIG. 7(B) shows a situation in which a smile is detected out of the smile area, and FIG. 7(C) shows a situation in which a smile is detected within the smile area.

[Figure 8] FIG. 8is a yet another example of the monitor screen applied to FIG. 1 embodiment and is an illustrative view when there are both of the main figure and the subsidiary figure within the smile area, and FIG. 8(A) shows an initial state, FIG. 8(B) shows a situation in which a smile on the subsidiary figure is detected within the smile area and FIG. 8(C) shows a situation in which a smile on the main figure is detected within the smile area.

[Figure 9] FIG. 8 is a further example of the monitor screen applied to FIG. 1 embodiment and is an illustrative view showing self-timer-like imaging method by utilizing the smile area, and FIG. 9(A) shows an initial state, FIG. 9(B) shows a situation in which a smile is detected out of the smile area, and FIG. 9(C) shows a situation in which a smile is detected within the smile area.

[Figure 10] FIG. 10 is an illustrative view showing a memory map applied to FIG. 1 embodiment memory, FIG. 10(A) shows a configuration of an SDRAM, and FIG. 10(B) shows a configuration of a flash memory.

[Figure 11] FIG. 11 is an illustrative view showing one example of a face information table applied to FIG. 1 embodiment.

[Figure 12] FIG. 12 is an illustrative view showing one example of a face state flag applied to FIG. 1 embodiment, and FIG. 10(A) to FIG. 10(C) respectively correspond to FIG. 6(A) to FIG. 6(C).

[Figure 13] FIG. 13 is a flowchart showing a part of an operation by a CPU applied to FIG. 1 embodiment.

[Figure 14] FIG. 14 is a flowchart showing another part of the operation by the CPU applied to FIG. 1 embodiment.

[Figure 15] FIG. 15 is a flowchart showing a still another part of the operation by the CPU applied to FIG. 1 embodiment.

[Figure 16] FIG. 16 is a flowchart showing a yet another part of the operation by the CPU applied to FIG. 1 embodiment.

[Figure 17] FIG. 17 is a flowchart showing a further part of the operation by the CPU applied to FIG. 1 embodiment.

[Figure 18] FIG. 18 is a flowchart showing a still another part of the operation by the CPU applied to FIG. 1 embodiment.

[Figure 19] FIG. 19 is a flowchart showing a yet another part of the operation by the CPU applied to FIG. 1 embodiment.

[Figure 20] FIG. 20 is a flowchart showing a further part of the operation by the CPU applied to FIG. 1 embodiment.

[Figure 21] FIG. 21 is a flowchart showing another part of the operation by the CPU applied to FIG. 1 embodiment.

[Figure 22] FIG. 22 is a flowchart showing a still another part of the operation by the CPU applied to FIG. 1 embodiment.

[Figure 23] FIG. 23 is a flowchart showing a yet another part of the operation by the CPU applied to FIG. 1 embodiment.

[Figure 24] FIG. 24 is a flowchart showing a further part of the operation by the CPU applied to FIG. 1 embodiment.

[Figure 25] FIG. 25 is one example of a monitor screen applied to another embodiment and is an illustrative view showing a situation in which the focus evaluating area is forcibly moved into the smile area.

[Figure 26] FIG. 26 is a flowchart showing a part of an operation by the CPU applied to FIG. 25 embodiment.

[Figure 27] FIG. 27 is a flowchart showing a part of an operation by the

CPU applied to another embodiment.

### FORMS FOR EMBODYING THE INVENTION

Referring to FIG. 1, a digital camera 10 according to this embodiment includes a focus lens 12. An optical image of an object scene is formed on an imaging surface 14f of an image sensor 14 through a focus lens 12 so as to undergo photoelectronic conversion here. Thus, electric charges indicating the object scene image, that is, a raw image signal is generated.

When a power source is turned on, through imaging processing is started. Here, a CPU 24 instructs a TG 18 to repetitively perform exposure and read charges for imaging a through image. The TG 18 applies a plurality of timing signals to the image sensor 14 in order to execute an exposure operation of the imaging surface 14f and a thinning-out reading operation of the electric charges thus obtained. A part of the electric charges generated on the imaging surface 14f are read out in an order according to a raster scanning in response to a vertical synchronization signal Vsync generated per 1/30 sec. Thus, a raw image signal of a low resolution (320*240, for example) is output from the image sensor 14 at a rate of 30 fps.

The raw image signal output from the image sensor 14 undergoes A/D conversion by a camera processing circuit 20 so as to be converted into raw image data being a digital signal. The raw image data is written to a raw image area 30a (see FIG. 10(A)) of an SDRAM 30 through a memory control circuit 28. The camera processing circuit 20 then reads the raw image data stored in the raw image area 30a through the memory control circuit 28 to perform processing, such as a color separation, a YUV conversion, etc. on it. Image data of a YUV format thus obtained is written to a YUV image area 30b (see FIG. 10(A)) of the SDRAM 30 through the memory control circuit 28.

An LCD driving circuit 32 reads the image data stored in the YUV image area 30b through the memory control circuit 28 every 1/30 seconds, and drives the LCD monitor 34 with the read image data. Consequently, a real-time motion image (through-image) of the object scene is displayed on the LCD monitor 34.

Here, although illustration is omitted, processing of evaluating the brightness (luminance) of the object scene based on the Y data generated by the camera processing circuit 20 is executed by a luminance evaluation circuit at a rate of 1/30 sec. during such a through imaging. The CPU 24 adjusts the light exposure of the image sensor 14 on the basis of the luminance evaluation value evaluated by the luminance evaluation circuit to thereby appropriately adjust the brightness of the through-image to be displayed on the LCD monitor 34.

A focus evaluation circuit 22 fetches Y data belonging to a focus evaluating area Efcs shown in FIG. 5(A) and etc. out of the Y data generated by the camera processing circuit 20, integrates the high-frequency component of the fetched Y data, and outputs the result of the integration, that is, a focus evaluation value. The series of processing is executed every 1/30 sec. in response to a vertical synchronization signal Vsync. The CPU 24 executes so-called continuous AF processing (hereinafter, simply referred to as “AF processing”; see FIG. 21) on the basis of the focus evaluation value thus evaluated. The position of the focus lens 12 in an optical axis direction is continuously changed by a driver 16 under the control of the CPU 24.

The CPU 24 further executes face recognition processing with the YUV data stored in the SDRAM 30 noted. The face recognition processing is one kind of pattern recognizing processing of checking face dictionary data 72 (see FIG. 10(B)) corresponding to the eyes, the nose, the mouth, etc. of a person against the noted YUV data, to thereby detect the image of the face of the person from the object scene image.

More specifically, as shown in FIG. 2, a face detecting box FD with a predetermined size (80*80, for example) is arranged at a start position (upper left) within an image frame, and the checking processing is performed on the image within the face detecting box FD while this is moved by a defined value in a raster scanning manner. When the face detecting box FD arrives at an end position (lower right of the screen), it is returned to the start position to repeat the same operation.

In another embodiment, a plurality of face detecting boxes being different in size are prepared, and by performing a plurality of detection processing in order or in parallel on the respective images, detection accuracy may be improved.

When a facial image is detected, the CPU 24 further calculates the size and the position of the facial image, and registers the result of the calculation as a “face size” and a “face position” in a face information table 70 (see FIG. 10(B), FIG. 11) along with an identifier (ID). More specifically, longitudinal and lateral lengths (the number of pixels) of the rectangular face box Fr around the facial image can be used as a size of the facial image, and barycentric coordinates of the face box Fr can be used as a position of the facial image. As an ID, a serial number 1, 2, . . . can be used. It should be noted that FIG. 11 shows numerical values in a case that the size of the through-image is regarded as 320*240.

In a case that the detected facial image moves out of the focus evaluating area Efcs, the CPU 24 moves the focus evaluating area Efcs with reference to the position of the facial image (see FIG. 5(B)). Accordingly, in the focus adjusting processing described above, in a case that a face is included in the object scene, the facial image is eventually mainly referred.

The CPU 24 further depicts (makes an on-screen display) the face box Fr on the through-image on the LCD monitor 34 by controlling the LCD driving circuit 32 through a character generator (CG) 42. In a case that the number of faces which is currently being detected, that is, the number of faces registered in the face information table 70 (hereinafter, simply referred to as “the number of faces”) is plural, an into-focus facial image through the aforementioned AF processing , that is, the facial image (hereinafter, referred to as a facial image of a “main figure”) within the focus evaluating area Efcs is depicted with a double face box Frd, and a facial image (is not necessary to be into focus) of a subsidiary figure is depicted with a single face box Frs (see FIG. 5(C)).

When a still image recording operation (the shutter button 26s is pushed) is performed during a through image imaging as described above, the CPU 24 instructs the TG 18 to perform an exposure and read charges for a main imaging processing. The TG 18 applies one timing signal to the image sensor 14 in order to execute one exposure operation on the imaging surface 14f and one all-pixels reading operation of the electric charges thus obtained. All the electric charges generated on the imaging surface 14f are read out in an order according to a raster scanning. Thus, a high-resolution raw image signal is output from the image sensor 14.

The raw image signal output from the image sensor 14 is converted into raw image data by the camera processing circuit 20, and the raw image data is written to the raw image area 30a of the SDRAM 30 through the memory control circuit 28. The camera processing circuit 20 reads the raw image data stored in the raw image area 30a through the memory control circuit 28, and converts the same into image data in a YUV format. The image data in a YUV format is written to a recording image area 30c (see FIG. 10(A)) of the SDRAM 30 through the memory control circuit 28. The I/F 36 reads the image data thus written to the recording image area 30c through the memory control circuit 28, and records the same in a file format into a recording medium 38.

When a mode selection starting operation (when the set button 26st is pushed) is performed by the key input device 26, the CPU 24 displays a mode selecting screen as shown in FIG. 2, for example, on the LCD monitor 34 by driving the LCD driving circuit 32 through the CG 42. The mode selecting screen includes letters (symbol marks may be possible in another embodiment) indicating selectable modes, such as normal recording, smile recording I, and smile recording II. At the letters indicating a mode which is being selected out of these letters, a cursor (underline) is placed. When a mode selecting operation (when the cursor key 26c is pushed) is performed by the key input device 26, the cursor (underline) on the screen moves to a position of the letters indicating another mode. When a decision operation (when the set button 26st is pushed again) is performed with a desired mode selected, the mode which is currently being selected becomes operative.

When the smile recording mode I is made operative, through imaging processing similar to the above description is started. Prior to this, the CPU 24 assigns a smile area (hereinafter, referred to as “designated smile area”) arbitrarily designated by the user to a frame corresponding to each of the images. In this embodiment, one area designated from five smile areas Es0 to Es4 shown in FIG. 4 is assigned. The default of the designated smile area is the smile area Es0 at the center. Alternatively, in another embodiment, a smile area including the focus evaluating area Efcs at this point may be regarded as a default.

The smile areas Es0 to Es4 shown in FIG. 4 are arranged within the imaging area Ep of the image sensor 14 (imaging surface 14f) as follows. That is, the CPU 24 divides the frame into 16*16=256 to thereby arrange the smile area Es0 in the center rectangular region indicated by (4, 4) to (11, 11), the smile area Es1 in the upper right rectangular region indicated by (7, 1) to (8, 14), the smile area Es2 in the upper left rectangular region indicated by (1, 1) to (8, 8), the smile area Es3 in the lower left rectangular region indicated by (1, 7) to (8, 14), and the smile area Es4 in the lower right rectangular region indicated by (7, 7) to (14, 14).

Accordingly, the smile areas Es0 to Es4 of this embodiment are partly overlapped with each other. In another embodiment, the five smile areas Es0 to Es4 may tightly be arranged, or may loosely be arranged.

Also, the number of areas is not restricted to five. The more the number of areas is, the higher the possibility of recording a target smile is, but in a case that the display color is changed for each area, due to the restriction on the number of useable colors, the number of areas may be four or less. In another embodiment, only the four smile area Es1 to Es4 from which the smile area at the center is removed from the smile areas Es0 to Es4 in FIG. 4 may be used. In still another embodiment, only one smile area Es0 may be used.

Furthermore, the shape of each area is not restricted to a rectangle, and may take other shapes like a circle and a regular polygon. Areas different in shapes and/or sizes may be mixed within the frame.

The designated smile area is changed in a following manner during imaging the through image in the smile recording mode I. When an area designation starting operation (when the set button 26st is pushed) is performed by the key input device 26, the CPU 24 makes an on-screen display of the designated smile area at this point by driving the LCD driving circuit 32 through the CG 42. If the designated smile area at this time is the smile area Es0 at the center of the screen, the smile area Es0 is displayed (see FIG. 6(A) and the like). Successively, when an area designating operation (when the cursor key 26c is pushed) is performed by the key input device 26, the on-screen display is updated to a new designated smile area.

Here, on the screen of FIG. 6(A) and the like, the outline of the designated smile area is displayed, but by displaying a colored translucent area image, and performing processing of changing a color tone and luminance on the object scene image within the area as well, the user can visually identify the designated smile area. Also, the smile areas Es0 to Es4 are depicted by different kinds of lines for the sake of convenience, but may be depicted in different colors. In addition, depending on a combination between the kind of lines and colors, each area may be identified.

Furthermore, in this embodiment, only the designated smile area is displayed, but in another embodiment, in response to a push of the set button 26st, five outlines indicating the five smile areas Es0 to Es4 are shown in different colors at the same time, and only the outline corresponding to the designated smile area may be emphasized.

The CPU 24 makes a smile mark Sm at a corner of the screen shown in FIG. 6(A) and the like by driving the LCD driving circuit 32 through the CG 42. On the screen shown in FIG. 6(A), a pause mark Wm is further displayed next to the smile mark Sm for representing that the smile recording processing is paused, but erased from the screen after restarting the processing (see FIG. 24).

Here, the smile mark Sm is also displayed in the smile recording mode II described later. In another embodiment, the manner of the smile mark Sm (color, shape, etc.) may be changed between the smile recording modes I and II.

While one facial image is detected, the CPU 24 further repetitively judges whether or not there is a characteristic of A smile there by noting a specific region of the facial image, that is, the corner of the mouth. If it is judges that there is a characteristic of a smile, it is further judged whether or not the face position is within the designated smile area. If the face position is within the area, a main imaging instruction is issued to execute recording processing while if the face position is out of the area, issuance of a main imaging instruction is suspended. Accordingly, if a smile is not detected within the designated smile area, recording processing is not executed.

While a plurality of facial images are detected, the CPU 24 further repetitively judges whether or not there is a characteristic of a smile as to each of the facial images. If it is judged that there is a characteristic of a smile in any one of the facial images, it is further judged whether or not the face position is within the designated smile area. If the smile is within the area, it is further judged whether or not the smile is the main figure. If it is the main figure, the main imaging processing and the recording processing are executed. If the smile is not the main figure, it is further judges whether or not there is a main figure within the designated smile area, and if there is no main figure within the area, the main imaging processing and the recording processing are executed. On the other hand, if the face position of the smile is out of the area, issuance of the main imaging instruction is suspended. Also, even if the face position of the smile is within the area, if this is the subsidiary figure and there is the main figure in the area, issuance of the main imaging instruction is suspended.

Accordingly, if a smile of someone is not detected within the designated smile area, recording processing is not executed. Then, if the main figure and the subsidiary figures are mixed within the designated smile area, a smile of the main figure is given high priority. In other words, the recording processing is executed only when the main figure has a smile within the designated smile area, or only when someone has a smile while there are only the subsidiary figures within the designated smile area. A case that the number of faces is two is described with reference to FIG. 6 to FIG. 8.

FIG. 6 shows one example of changes of the screen when the number of faces is two, the designated smile area is the smile area Es0 at the center, and there is only a face Fc1 of the main figure within the smile area Es0. The face Fc1 is positioned at an approximately the center of the screen, and a face Fc2 is positioned at the lower left of the screen. The face Fc1 being closer to the center of the screen is selected as a main figure. Around the face Fc1 of the main figure, the double face box Frd is depicted, and around the face Fc2 of the subsidiary figure, the single face box frs is depicted.

At a time of FIG. 6(A), neither of the two faces Fc1 and Fc2 smile. Thereafter, if the face Fc2 has a smile as shown in FIG. 6(B), the smile is out of the smile area Es0, and therefore, recording processing is never executed at this timing. On the other hand, if the face Fc1 has a smile as shown in FIG. 6(C), the smile is within the smile area Es0, and therefore, recording processing is executed at this timing.

FIG. 7 shows one example of changes of the screen in a case that the number of faces is two, the designated smile area is the smile area Es3 at the lower left, and there is only the face Fc2 of the subsidiary figure within the smile area Es3. The positional relationship between two smiles Fs1 and Fs2 and arrangements of the double face box Frd and the single face box Frs are similar to FIG. 6.

At a time of FIG. 7(A), neither of the two faces Fc1 and Fc2 smile. Thereafter, as shown in FIG. 7(B), if the face Fc1 has a smile, the smile is positioned out of the smile area Es3, and therefore, recording processing is never executed at this timing. On the other hand, as shown in FIG. 7(C), if the face Fc2 has a smile, the smile is positioned within the smile area Es3, and therefore, recording processing is executed at this timing.

FIG. 8 shows one example of changes of the screen in a case that the number of faces is two, the designated smile area is the smile area Es0 at the center, and there are the face Fc1 of the main figure and the face Fc2 of the subsidiary figure within the smile area Es0. On the screen, both of the face Fc1 and the face Fc2 are positioned at an approximately the center of the screen, but the former is still closer to the center of the screen, and therefore, the double face box Frd is arranged around the face Fc1, and the single face box Frs is arranged around the face Fc2.

At a time of FIG. 8(A), neither of the two faces Fc1 and Fc2 smile. Thereafter, if the face Fc2 has a smile as shown in FIG. 8(B), the smile is of the subsidiary figure, and recording processing is never executed at this timing. On the other hand, if the face Fc2 has a smile as shown in FIG. 8(C), the smile is of the main figure, and therefore, recording processing is executed at this timing.

As a characteristic utilizing method of such a smile recording mode I, there is “self-timer-like imaging”. The photographer assumes a standing position of his or her own, designates the smile area within which there is only the face of his or her own, and moves to the assumed position and then has a smile to thereby surely record his or her own smile. The detailed example is shown in FIG. 9.

In FIG. 9(A), there is the face Fc1 other than the own face toward the right of the center of the screen, and the photographer designates the smile area Es2 at the upper left while assuming his or her own standing position. The face Fc1 is out of the smile area Es2, and does not have a smile. Thereafter, when the photographer moves to the assumed position, the face Fc2 of the photographer of his or her own appears in the smile area Es2. The face Fc2 does not have a smile also. As to the two faces Fc1 and Fc2, the former is closer to the center of the screen, and therefore, the face Fc1 becomes the main figure.

Thereafter, as shown in FIG. 9(B), the face Fc1 shall have a smile. However, the face Fc1 is out of the smile area Es2, and therefore, recording processing is not executed. On the other hand, if the face Fc2 has a smile as shown in FIG. 9(C), it is within the smile area Es2, and therefore, recording processing is executed. Thus, the photographer can arbitrarily decide an execution timing of the recording processing while being in the object scene.

Here, if imaging similar to the above description is performed in the smile recording mode II described next, recording processing may be executed in response to a smile other than the own face (face Fc1 in FIG. 9).

When the smile recording mode II is made operative, through imaging processing as described above is started. While one or a plurality of facial images is detected, the CPU 24 further repetitively judges whether or not there is a characteristic of the smile there by noting a specific region of the facial image, that is, the corner of the mouth. If it is judged that there is a characteristic of a smile in any facial image, a main imaging instruction is issued to execute recording processing.

The smile recording mode II is different from the smile recording mode I in a point that the smile recording is performed on the entire screen without being restricted to the designated smile area, and face detecting processing and smile evaluating processing are similar to those in the smile recording mode I.

The smile recording operation as described above is implemented by the CPU 24 by controlling the respective hardware element shown in FIG. 1 to execute a mode selecting task shown in FIG. 13, a main task specific to the smile recording I mode (hereinafter, sometimes referred to as “main task (I)”: this holds true for other tasks) shown in FIG. 14, a smile area controlling task specific to the smile recording I mode shown in FIG. 15, a flag controlling task specific to the smile recording I mode shown in FIG. 16 and in FIG. 17, a main task specific to the smile recording II mode shown in FIG. 18, a flag controlling task specific to the smile recording II mode shown in FIG. 19, a pausing task shared with I·II modes shown in FIG. 20, an AF task shared with the I·II modes shown in FIG. 21, a face detecting task shared with the I•II modes shown in FIG. 22, a face box controlling task shared with the I•II modes shown in FIG. 23, and a mark controlling task shared with the I•II modes shown in FIG. 24. Here, the CPU 24 can process two or three or more tasks out of these ten tasks under the control of the multitasking OS.

Ten programs 50 to 68 corresponding to these ten tasks are stored in a program area 40a (see FIG. 10(B)) of the flash memory 40. In a data area 40b of the flash memory 40, a designated smile area identifier 74 indicating the designated smile area at this time (any one of Es0 to Es4), a standby flag (W)76 being switched between ON and OFF in accordance with the smile area controlling task (see FIG. 15) and the pausing task (see FIG. 20), and a face state flag (A1, 2, . . . , P1, P2, . . . , S1, S2, . . . ) 78 being switched between ON and OFF in accordance with the flag controlling task (see FIG. 16 and FIG. 19) are further stored in addition to the aforementioned face information table 70 and face dictionary data 72.

Here, “A” being a kind of the face state flag is a flag indicating whether the position of the facial image is within or out of the designated smile area, and ON corresponds to the inside and OFF corresponds to the outside. “P” being another kind of the face state flag is a flag indicating whether or not the facial image is the main figure or the subsidiary figure, and ON corresponds to the main figure and OFF corresponds to the subsidiary figure. “S” being a still another kind of the face state flag is a flag indicating whether the facial image has a smile or others (the latter is arbitrarily referred to as “non-smile”), and ON corresponds a smile and OFF corresponds to a non-smile. The subscript 1, 2, . . . of each flag is an ID for identifying the facial images.

For example, the states of the two facial images Fc1 and Fc2 in FIG. 6(A) are described by the face state flag as shown in FIG. 12(A). Similarly, the states of the two facial images Fc1 and Fc2 in FIG. 6(B) are described as shown in FIG. 12(B), and the states of the two facial images Fc1 and Fc2 in FIG. 6(C) are described as shown in FIG. 12(C).

With reference first to FIG. 13, when a menu key (not illustrated) of the key input device 26 is pushed, the CPU 24 displays a menu screen shown in FIG. 2 on the LCD monitor 34 by controlling the CG 42 and the like and the LCD driving circuit 32 in a step S1. Next, in a step S3, it is determined whether or not the “smile recording I” is selected by operations of the cursor key 26c and the SET key 26, and if “YES”, the smile recording I mode is made operative. If “NO” in the step S3, it is determined whether or not the “smile recording II” is selected in a step S5, and if “YES”, the smile recording II mode is made operative. If “NO” in the step S5, it is determined whether or not another recording mode, such as the “normal recording mode” is selected in a step S7, and if “YES”, the recording mode is made operative. If “NO” in the step S7, it is determined whether or not a cancel operation is performed in a step S9, and if “YES”, the process returns to the mode immediately before the menu key is pushed. If “NO” in the step S9, the process returns to the step S3 to repeat similar processing.

First, the smile recording I mode is described. When the smile recording I mode is made operative, the main task (I) is first activated, and the CPU 24 starts to execute a flowchart (see FIG. 14) corresponding thereto. Referring to FIG. 14, in a step S21, “0” is set to the flag W. In a step S23, the smile area controlling task (I), the flag controlling task (I), the pausing task, the AF task, the face detecting task, the face box controlling task and the mark controlling task are activated, and the CPU 24 further starts to execute flowcharts (see FIG. 15 to FIG. 17, FIG. 20 to FIG. 24) corresponding thereto.

In a step S25, a through imaging instruction is issued, and in response thereto, the aforementioned through imaging processing is started. In a step S27, it is determined whether or not a Vsync is generated by the signal generator not shown, and if “NO”, it goes standby. If “YES” in the step S27, the flag W is “0” in a step S29, and if “NO”, the process returns to the step S27. If “YES” in the step S29, the process shifts to a step S31 to determine whether or not someone has a smile on the basis of a change of state of the flags S1, S2, . . . out of the face state flag 78, and if “NO” here, the process returns to the step S27.

If any one of the flags S1, S2, . . . is changed from the OFF state to the ON state, “YES” is determined in the step S31, and the process proceeds to a step S33. In the step S33, it is determined whether or not a new smile (face ID shall be “m”) is within the designated smile area on the basis of the position of the face m registered in the face state table 70 (see FIG. 11) and the designated smile area identifier 74, and if “NO”, the process returns to the step S27. Here, the CPU 24 recognizes the position on the screen of each smile area Es0 to Es4 shown in FIG. 4.

If “YES” in the step S33, the process shifts to a step S35 to determine whether or not this smile is of the main figure on the basis of the flag Pm out of the face state flag 78. If “YES” in the step S35, a main imaging instruction is issued in a step S39, and recording processing is executed by controlling the I/F 36 in a step S41. Accordingly, if this smile is within the designated smile area and is of the main figure, a still image including this smile is recorded in the recording medium 38.

If “NO” in the step S35, it is determined whether or not there is a face of the main figure within the designated smile area on the basis of the face state flag 78 in a step S37, and if “NO”, the above-described steps S39 and S41 are executed. With reference to the face state flag 78, if there is a face about which the flag A is turned on, the flag P is turned on, and the flag S is turned off, “YES” is determined in the step S37, and the process returns to the step S27. Accordingly, if this smile is within the designated smile area and is of the subsidiary figure, only when there is no face of the main figure within the designated smile area, recording processing is executed. If there is the face of the main figure within the designated smile area, recording processing is executed at a time when the face of the main figure has a smile thereafter.

With reference to FIG. 15, when the smile area controlling task (I) is activated, a default (smile area “Es0” in this embodiment) is set to the designated smile area identifier 74 in a step S51. Here, in another embodiment, after a wait for any facial image to be into focus by the AF task (see FIG. 21), and the smile area including this facial image may be set to a default.

In a step S53, it is determined whether or not the set button 26st is pushed, and if “NO”, it goes standby. If “YES” in the step S53, the process proceeds to a step S55 to set “1” to the flag W, and then, the designated smile area is displayed on the LCD monitor 34 by controlling the CG 42 and the like in a step S57. If the designated smile area identifier 74 is “Es0”, for example, the smile area Es0 is displayed (see FIG. 6(A)), and if it is “Es3”, the smile area Es3 is displayed (see FIG. 7(A)).

In a step S59, it is determined whether or not the cursor key 26c is operated, and if “NO” here, it is further determined whether or not the set button 26st is pushed in a step S61, and if “NO” here as well, the process returns to the step S57 to repeat similar processing. If “YES” in the step S59, the process proceeds to a step S63 to update the value of the designated smile area identifier 74, and the process then returns to the step S57 to repeat similar processing. If “YES” in the step S61, the process proceeds to a step S65 to erase the designated smile area from the monitor screen, “0” is set to the flag W in a step S67, and then, the process returns to the step S53 to repeat similar processing.

With reference to FIG. 16 and FIG. 17, when the flag controlling task (I) is activated, “1” is set to the variable I in a step S71, and then, generation of Vsync is waited in a step S73. When a Vsync is generated, the process proceeds to a step S75 to determine whether or not the face i is within the designated smile area on the basis of the face information table 70 and the designated smile area identifier 74. If the determination result is “YES”, the flag Ai is turned on in a step S77, and if “NO”, the flag Ai is turned off in a step S79. Then, in a step S81, it is further determined whether or not the face i is of the main figure.

If the face i is into focus (that is, if the face i is marked by the double face box) as a result of the AF task, “YES” is determined in the step S81, the flag Pi is turned on in a step S83, and then, the process proceeds to a step S87. If “NO” in the step S81, the flag Pi is turned off in a step S85, and then, the process proceeds to the step S87. In the step S87, the image of the specific region (the corner of the mouth, the corner of the eye, etc.) is cut out from the image of the face i. Then, it is determined whether or not there is a characteristic of a smile in the cut image (has a slanted corner of the mouth, has crow's feet at the corner of the eye, etc.) in a step S89. If “YES”, the flag Si is turned on in a step S91 while if “NO”, the flag Si is turned off in a step S93. Then, in a step S95, the variable i is incremented, and it is determined whether or not the variable i is above the number of faces in a step S97. If “YES”, the process returns to the step S71 in order to repeat similar processing, and if “NO”, the process returns to the step S75 in order to repeat similar processing. Here, the determination in the step S89 can specifically be performed on the basis of the fact that the shape of the mouth on the face matches the face dictionary data 72.

With reference to FIG. 20, when the pausing task is activated, it is determined whether or not the shutter button 26st is pushed in a step S141, and if “NO”, it goes standby. If “YES” in the step S141, “1” is set to the flag W in a step S143. Then, the process proceeds to a step S145 to determine whether or not the shutter button 26st is pushed, and if “NO”, it goes standby. If “YES” in the step S145, “0” is set to the flag W in a step S147, and then, the process returns to the step S141 to repeat similar processing.

With reference to FIG. 21, when the AF task is activated, generation of a Vsync is waited in a step S151, and then, it is determined whether or not the focus evaluation value at this point satisfies an AF activating condition in a step S153. If “NO” here, the process returns to the step S151 to repeat similar processing. If “YES” in the step S153, the process proceeds to a step S155 to execute AF processing. Here, in the AF processing, in a case that the number of faces is plural, a focus adjustment is performed by noting the face of the main figure decided in a face box controlling task in a step S187 (see FIG. 23: described later), and thus, the face of the main figure is focused on. After completion of the adjustment, the process returns to the step S151 to repeat similar processing.

With reference to FIG. 22, when the face detecting task is activated, the face information table 70 (see FIG. 11) is initialized in a step S161. Next, in a step S163, the face detecting box FD is arranged at the start position (upper left of the screen, for example: see FIG. 3), and then, in a step S165, generation of a Vsync is waited. When a Vsync is generated, the process proceeds to a step S167 to cut out the image within the face detecting box FD from the object scene image. Then, in a step S169, checking processing between the cut image and the face dictionary data 72 is performed, and it is determined whether or not the result of the check is matching in a step S171. If “NO” in the step S171, the process returns to the step S167 to repeat similar processing, and if “YES”, the facial information (ID, position and size) in relation to the face is described in the face information table 70 in a step S173. Then, it is determined whether or not there is an unchecked portion in a step S175. If “YES”, the face detecting box FD is moved by one step as in a manner shown in FIG. 3 in a step S177, and then, the process returns to the step S167 to repeat similar processing. If the face detecting box FD has arrived at the lower right of the screen, “NO” is determined in the step S175, and the process returns to the step S163 to repeat similar processing.

With reference to FIG. 23, when the face box controlling task is activated, generation of a Vsync is waited in a step S181, and then, it is determined whether or not a face is detected on the basis of the face information table 70 in a step S183. If “NO”, the process returns to the step S181 to repeat similar processing. If at least one face is registered in the face information table 70, “YES” is determined in the step S183, and the process proceeds to a step S185 to further determine whether or not the number of faces is plural. If “YES” in the step S185, the process proceeds to a step S189 through a step S187 while if “NO”, the process proceeds to the step S189 by skipping the step S187.

In the step S187, the main figure is decided on the basis of a positional relationship among the respective faces. Here, the distance from the center of the screen to each of the facial images is calculated, and the facial image for which the result of the calculation is the minimum is regarded as a main figure. In another embodiment, the distance from the digital camera 10 to each of the facial images is calculated, and the main figure may be decided by taking the result of calculation into account, such as removal of the farthest face and the closest face from the candidate of the main figure, etc. In the step S189, the face box Fr along the outline of each face (see FIG. 5(A) and the like) is displayed by controlling the CG 42 and the like. In a case that the number of faces is plural, the double face box Frd is assigned to the face of the main figure, and the single face box Frs is assigned to the face of the subsidiary figure (see FIG. 5(C) and the like). After display of the face box, the process returns to the step S181 to repeat similar processing.

With reference to FIG. 24, when the mark controlling task is activated, in a step S201, generation of a Vsync is waited, and a smile mark Sm (see FIG. 6(A) and the like) is displayed by controlling the CG 42 and the like. Then, the process proceeds to a step S205 to determine whether or not the flag W is “1”. If “YES” in the step S205, the pause mark Wm is further displayed in a step S207, and if “NO” in the step S205, the pause mark Wm is erased from the monitor screen in a step S209. After execution of the step S205 or S207, the process returns to the step S201 to repeat similar processing.

Next, the smile recording II mode is described. When the smile recording II mode is made operative, the main task (II) is first activated, and the CPU 24 starts to execute a flowchart (see FIG. 18) corresponding thereto. With reference to FIG. 18, in a step S101, “0” is set to the flag W. In a step S103, the flag controlling task (II), the pausing task, the AF task, the face detecting task, the face box controlling task and the mark controlling task are activated, and the CPU 24 further starts to execute flowcharts (see FIG. 19, FIG. 20 to FIG. 24) corresponding thereto.

In a step S105, a through imaging instruction is issued, and in response thereto, through imaging processing is started. In a step S107, it is determined whether or not a Vsync is generated, and if “NO”, it goes standby. If “YES” in the step S107, it is determined whether or not the flag W is “0” in a step S109, and if “NO”, the process returns to the step S107. If “YES” in the step S109, the process shifts to a step S111 to determine whether or not someone has a smile on the basis of a change of state of the flags S1, S2, . . . , and if “NO” here, the process returns to the step S107.

When any one of the flags S1, S2, . . . changes from the OFF state to the ON state, “YES” is determined in the step S111, and the process proceeds to a step S113 to issue a main imaging instruction. Thereafter, the process proceeds to the step S41 to control the I/F 36 to execute recording processing. Accordingly, if someone has a smile within the screen, a still image including the smile is recorded into the recording medium 38. After recording, the process returns to the step S105 to repeat similar processing. Here, in another embodiment, similar to the smile recording mode I, the main figure is given high priority. That is, even if the subsidiary figure has a smile, a main imaging instruction is not issued, and only when the main figure has a smile, this is issued.

With reference to FIG. 19, when the flag controlling task (II) is activated, “1” is set to the variable i in a step S121, and generation of a Vsync is waited in a step S123. When a Vsync is generated, the process proceeds to a step S125 to cut out an image of the specific region from the image of the face i. Then, it is determined whether or not there is a characteristic of a smile in the cut image in a step S127, and if “YES”, the flag Si is turned on in a step S129 while if “NO”, the flag Si is turned off in a step S131. Then, in a step S133, the variable i is incremented, and it is determined whether or not the variable i is above the number of faces in a step S135. If “YES”, the process returns to the step S121 to repeat similar processing, and if “NO”, the process returns to the step S125 to repeat similar processing. Here, the determination in the step S127 can be performed on the basis of the fact that the shape of the mouth of the face matches the face dictionary data 72, for example.

Each processing of FIG. 20 to FIG. 24 is similar to those of the smile recording I mode, and the explanation thereof is omitted.

Here, in another embodiment, recording a still image may be performed during recording of a motion image without being restricted to be performed during recording a through image. Here, in this case, the recording size (resolution) of the still image is the same as that of the motion image. For example, in a mode of recording the motion image the same size as the through image, image data of the YUV image area 30b is copied in the recording image area 30c. The recording image area 30c has a capacity corresponding to 60 frames, for example, and when the recording image area 30c is filled to capacity, the image data of the oldest frame is overwritten with the latest image data from the YUV image area 30b. Thus, in the motion image area, image data of immediate 60 frames is always stored.

When a motion image record starting operation is performed by the key input device 26, the CPU 24 instructs the I/F 36 to perform motion image recording processing, and the I/F 36 periodically performs reading of the motion image area through the memory control circuit 28, and creates a motion image file including the read image data in the recording medium 38. Such the motion image recording processing is ended in response to an ending operation by the key input device 26.

When a still image recording operation (when the shutter button 26s is pushed) is performed during execution of the motion image recording processing, the CPU 24 instructs the I/F 36 to read the image data of the frame nearest to when the shutter is pushed out of the image data recorded in the recording image area 30c through the memory control circuit 28, and records the same in a file format into the recording medium 38.

The aforementioned smile recording I mode and smile recording II mode can also be applied to recording of a still image during recording of a motion image. In this case, in the smile recording mode I, when someone has a smile within the designated smile area of the frame, the CPU 24 may record the image data of the frame including this smile out of the image data recorded in the recording image area 30c into the recording medium 38 through the I/F 36. In the smile recording mode II, when someone has a smile somewhere in the frame, the CPU 24 may record the image data of the frame including this smile out of the image data recorded in the recording image area 30c in the recording medium 38 through the I/F 36.

Also, in another embodiment, when the main figure and the subsidiary figure are arranged as shown in FIG. 7(A), the focus evaluating area Efcs may forcibly be moved to the designated smile area as shown in FIG. 25. In this case, the CPU 24 further executes AF area restricting task as shown in FIG. 26 in the aforementioned smile recording mode I. In a step S221, it is determined whether or not the focus evaluating area Efcs is out of the designated smile area, and if “NO”, it goes standby while if “YES”, the focus evaluating area Efcs is forcibly moved into the designated smile area in a step S223. Then, the process returns to the step S221 to repeat similar processing. Thus, it is possible to heighten a possibility of coming into focus with the target for the smile recording.

In this point, in the aforementioned smile recording mode I, in a case that the main figure and the subsidiary figure are arranged as shown in FIG. 7(A) , and there is a great difference in depth between the main figure and the subsidiary figure, the focus is achieved into the main figure, and thus, a smile judgment is not properly performed on the subsidiary figure, or even if a smile judgment is properly performed, a target smile may be out of focus in the recorded image. However, following the movement of the face by the focus evaluating area Efcs is used to arrange the face Fc2 of a target for smile recording at the center of the screen once and to display the double face box Frd on the face Fc2. Then, if a camera operation is performed so as to switch to the composition shown in FIG. 7 by changing a camera angle by the user, such a possibility is reduced.

As understood from the above description, the digital camera 10 according to this embodiment includes the CPU 24. The CPU 24 repetitively captures an object scene image formed on the imaging surface 14f by controlling the image sensor 14 (S25, S39, S105, S113), detects a facial image from each object scene image thus created (S161 to S177), judges whether or not the face of each of the detected facial images has a smile (S71 to S97, S121 to S135), and records the object scene image created after the judgment result about which at least one detected facial image is changed from the state indicating a non-smile to the state indicating a smile into the recording medium 38 by controlling the I/F 36 (S31, S41, S111, S115).

Then, the CPU 24 assigns an area to each object scene image in response to an area designating operation via the key input device 26 in the smile recording I mode (S63), and restricts execution of the recording processing on the basis of at least a positional relationship between the facial image which is judged as having a smile and the assigned area (S33 to S37). Thus, it is possible to record a target smile with a high probability. On the other hand, in the smile recording II mode, there is no such a restriction, capable of recording arbitrary smiles in a wide range.

Furthermore, in this embodiment, a smile judgment is performed throughout the imaging area Ep (that is, out of the designated smile area also), but the smile judgment may be performed only within the designated smile area. This makes it possible to lighten the processing load by the CPU 24.

Also, in this embodiment, the smile judgment is performed on the basis of a change of the specific region of the face (slanted corner of the mouth, etc.), but this is merely one example, and various judgment methods can be used. For example, the degree of a smile is represented by numerical values by noting the entire face (outline and distribution of wrinkles, etc.) and each region (corner of the mouth, the corner of the eye, etc.), and the judgment may be performed based on the obtained numerical values.

Moreover, in this embodiment, the two smile recording modes including the smile recording I and II are prepared, but in a single mode, the smile recording using designation of the smile area and the smile recording not using the smile area (that is, in the entire imaging area Ep) are utilized as necessary. This embodiment is described hereunder. The hardware configuration according to this embodiment is similar to FIG. 1, and the CPU 24 executes processing as shown in FIG. 27 when the smile recording mode is made operative.

In a first step S321, a through imaging instruction is issued, and then, the process proceeds to a step S233 to determine whether or not there is an area designating operation by the key input device 26. If “YES” in the step S233, assigning the designated smile area is performed in a step S235, and the process returns to the step S233 to repeat similar processing. If “NO” in the step S233, cancelling the designated smile area is performed in a step S239, and the process returns to the step S233 to repeat similar processing. Here, in a case that the through display is suspended at an area designation or an area cancellation, the process has to return from the step S235 or S239 to the step S231.

If “NO” in the step S237, the process shifts to a step S241 to determine whether or not the designated smile area is assigned. If “YES” here, smile detection is performed within the designated smile area, and if “NO”, smile detection is performed over the entire imaging area Ep. The smile detection here corresponds to the processing combining the aforementioned face detection and face judgment. It is determined whether or not someone has a smile on the basis of the detection result in a step S247, and if “YES”, a main imaging instruction is issued in a step S249, and recording processing is executed in a step S251. If “NO” in the step S247, the process returns to the step S233 to repeat similar processing.

In the above description, a description is made on the digital camera 10 (digital still camera, digital movie camera, etc.) as one example, but the present invention can be applied to an imaging device having an image sensor (CCD, CMOS, etc.), a recorder for recording an image based on an output from the image sensor into the recording medium (memory card, hard disk, optical disk, etc.), an operator (key input device, touch panel, etc.) to be operated by the user and the processor.

Although the present invention has been described and illustrated in detail, it is clearly understood that the same is by way of illustration and example only and is not to be taken by way of limitation, the spirit and scope of the present invention being limited only by the terms of the appended claims.

### EXPLANATION OF REFERENCE CHARACTERS

10 . . . digital camera
12 . . . focus lens
14 . . . image sensor
14 . . . imaging surface
20 . . . camera processing circuit
22 . . . focus evaluation circuit
24 . . . CPU
26 . . . key input device
42 . . . character generator

1. An imaging device, comprising:
an imager which repetitively captures an object scene image formed within an imaging area on an imaging surface;
an assigner which assigns a smile area to said imaging area in response to an area designating operation via an operator; and
a smile recorder which performs smile recording processing for detecting a smiling image from each of said object scene images created by said imager and recording the object scene image including said smiling image, within said smile area if said smile area is assigned by said assigner, and performs said processing within said imaging area if said smile area is not assigned by said assigner.

2. An imaging device, comprising:
an imager which repetitively captures an object scene image formed on an imaging surface;
a detector which detects a facial image from each of said object scene images created by said imager;
a judger which judges whether or not a face of each facial image detected by said detector has a smile;
a recorder which records in a recording medium an object scene image created by said imager after the judgment result by said judger about at least one facial image detected by said detector changes from a state indicating a non-smile to a state indicating a smile;
an assigner which assigns an area to each of said object scene images in response to an area designating operation via an operator in a specific mode; and
a restricter which restricts the execution of the recording processing by said recorder on the basis of at least a positional relationship between the facial image that is judged as having a smile by said judger and the area assigned by said assigner.

3. An imaging device according to claim 2, wherein said restricter allows execution of the recording processing by said recorder in a case that the facial image that is judged as having a smile by said judger is positioned within the area assigned by said assigner and restricts execution of the recording processing by said recorder in a case that the facial image that is judged as having a smile by said judger is positioned out of the area assigned by said assigner.

4. An imaging device according to claim 3, further comprising a focus adjuster which makes a focus adjustment so as to come into focus with one of the facial images detected by said detector, wherein
said restricter, in a case that there are an into-focus facial image and an out-of-focus facial image within the area assigned by said assigner, notes the into-focus-facial image.

5. An imaging device according to claim 4, further comprising a controller which controls a position of a focus evaluating area to be referred by said adjuster so as to come into focus with a facial image positioned within the area assigned by said assigner out of the facial images detected by said detector.

6. An imaging device according to claim 1, wherein said area designating operation is an operation for designating one from a plurality of fixed areas.

7. An imaging device according to claim 6, wherein parts of said plurality of fixed areas are overlapped with each other.

8. An imaging device according to claim 1, further comprising:
a through displayer which displays a through-image based on each object scene image created by said imager on a display; and
a depicter which depicts a box image representing the area designated by said area designating operation on the through-image of said display.

9. A smile recording program causing a processor of an imaging device including an image sensor having an imaging surface, a recorder recording an image based on an output from said image sensor on a recording medium and an operator to be operated by a user to execute:
an imaging step for repetitively capturing an object scene image formed within an imaging area on an imaging surface by controlling said image sensor;
an assigning step for assigning a smile area to said imaging area in response to an area designating operation via an operator; and
a smile recording step for performing smile recording processing of detecting a smiling image from each of said object scene images created by said imaging step and recording the object scene image including said smiling image, within said smile area if said smile area is assigned by said assigning step, and performing said processing within said imaging area if said smile area is not assigned by said assigning step.

10. A smile recording program causing a processor of an imaging device including an image sensor having an imaging surface, a recorder recording an image based on an output from said image sensor on a recording medium and an operator to be operated by a user to execute:
an imaging step for repetitively capturing an object scene image formed on said imaging surface by controlling said image sensor;
an detecting step for detecting a facial image from each of said object scene images created by said imaging step;
a judging step for judging whether or not a face of each facial image detected by said detecting step has a smile;
a smile recording step for recording in said recording medium an object scene image created by said imaging step after the judgment result by said judging step about at least one facial image detected by said detecting step changes from a state indicating a non-smile to a state indicating a smile by controlling said recording step;
an assigning step for assigning an area to each of said object scene images in response to an area designating operation via said operator in a specific mode; and
a restricting step for restricting the execution of the recording processing by said smile recording step on the basis of at least a positional relationship between the facial image that is judged as having a smile by said judging step and the area assigned by said assigning step.

11. A recording medium storing a smile recording program causing a processor of an imaging device including an image sensor having an imaging surface, a recorder recording an image based on an output from said image sensor on a recording medium and an operator to be operated by a user to execute:
an imaging step for repetitively capturing an object scene image formed within an imaging area on an imaging surface by controlling said image sensor;
an assigning step for assigning a smile area to said imaging area in response to an area designating operation via an operator; and
a smile recording step for performing smile recording processing of detecting a smiling image from each of said object scene images created by said imaging step and recording the object scene image including said smiling image, within said smile area if said smile area is assigned by said assigning step, and performing said processing within said imaging area if said smile area is not assigned by said assigning step.

12. A recording medium storing a smile recording program causing a processor of an imaging device including an image sensor having an imaging surface, a recorder recording an image based on an output from said image sensor on a recording medium and an operator to be operated by a user to execute:
an imaging step for repetitively capturing an object scene image formed on said imaging surface by controlling said image sensor;
an detecting step for detecting a facial image from each of said object scene images created by said imaging step;
a judging step for judging whether or not a face of each facial image detected by said detecting step has a smile;
a smile recording step for recording in said recording medium an object scene image created by said imaging step after the judgment result by said judging step about at least one facial image detected by said detecting step changes from a state indicating a non-smile to a state indicating a smile by controlling said recorder;
an assigning step for assigning an area to each of said object scene images in response to an area designating operation via said operator in a specific mode; and
a restricting step for restricting the execution of the recording processing by said smile recording step on the basis of at least a positional relationship between the facial image that is judged as having a smile by said judging step and the area assigned by said assigning step.

13. A smile recording method to be executed by an imaging device including an image sensor having an imaging surface, a recorder recording an image based on an output from said image sensor on a recording medium and an operator to be operated by a user, comprising:
an imaging step for repetitively capturing an object scene image formed within an imaging area on an imaging surface by controlling said image sensor;
an assigning step for assigning a smile area to said imaging area in response to an area designating operation via an operator; and
a smile recording step for performing smile recording processing of detecting a smiling image from each of said object scene images created by said imager and recording the object scene image including said smiling image, within said smile area if said smile area is assigned by said assigning step, and performing said processing within said imaging area if said smile area is not assigned by said assigning step.

14. A smile recording method to be executed by a processor of an imaging device including an image sensor having an imaging surface, a recorder recording an image based on an output from said image sensor on a recording medium and an operator to be operated by a user, comprising:
an imaging step for repetitively capturing an object scene image formed on said imaging surface by controlling said image sensor;
an detecting step for detecting a facial image from each of said object scene images created by said imaging step;
a judging step for judging whether or not a face of each facial image detected by said detecting step has a smile;
a smile recording step for recording in said recording medium an object scene image created by said imaging step after the judgment result by said jading step about at least one facial image detected by said detecting step changes from a state indicating a non-smile to a state indicating a smile by controlling said recorder;
an assigning step for assigning an area to each of said object scene images in response to an area designating operation via said operator in a specific mode; and
a restricting step for restricting the execution of the recording processing by said smile recording step on the basis of at least a positional relationship between the facial image that is judged as having a smile by said judging step and the area assigned by said assigning step.
